(19) United States
(12) Patent Application Publication
(10) Pub. No.: US 2025/0106428 A1
(43) Pub. Date: Mar. 27, 2025

(54) METHODS AND APPARATUSES FOR ENCODING/DECODING A VIDEO

(71) Applicant: InterDigital CE Patent Holdings, SAS, Paris (FR)

(72) Inventors: Franck Galpin, Thorigne-Fouillard (FR); Philippe Bordes, Laille (FR); Guillaume Boisson, Pleumeleuc (FR); Tangi Poirier, Thorigne-Fouillard (FR)

(21) Appl. No.: 18/850,870

(22) PCT Filed: Mar. 24, 2023
(86) PCT No.: PCT/EP2023/057740

§ 371 Date: Sep. 25, 2024

(30) Foreign Application Priority Data
Mar. 30, 2022 (EP) 22305402.4

(51) Int. Cl. H04N 19/51; H04N 19/176

(52) U.S. Cl. CPC H04N 19/51; H04N 19/176

(57) ABSTRACT

A method and an apparatus for encoding or decoding a video are provided. At least one motion compensation interpolation filter for a block of the video is determined. In an embodiment, the length of the motion compensation interpolation filter is adapted based on block conditions. A prediction block is determined based on the at least one motion compensation interpolation filter and a reference block determined for the block and the block of the video is encoded or decoded based at least on the prediction block.

### TECHNICAL FIELD

The present embodiments generally relate to a method and an apparatus for video encoding or decoding. Some embodiments relate to a method and an apparatus for video encoding or decoding using adapted interpolation motion compensation filters.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

According to a first aspect, a method for encoding a video is provided, wherein at least one motion compensation interpolation filter for a block of the video is determined and a prediction block is determined based on the at least one motion compensation interpolation filter and a reference block. The block is encoded based at least on the prediction block.

An apparatus for encoding a video is provided. The apparatus comprises one or more processors, wherein said one or more processors are configured to encode a block of the video. For that, the one or more processors are configured to determine at least one motion compensation interpolation filter for the block, determine a prediction block based on the at least one motion compensation interpolation filter and a reference block, encode the block based at least on the prediction block.

According to another aspect, a method for decoding a video is provided, wherein at least one motion compensation interpolation filter for a block of the video is determined and a prediction block is determined based on the at least one motion compensation interpolation filter and a reference block. The block is decoded based at least on the prediction block.

An apparatus for decoding a video is provided. The apparatus comprises one or more processors, wherein said one or more processors are configured to decode a block of the video. For that, the one or more processors are configured to determine at least one motion compensation interpolation filter for the block, determine a prediction block based on the at least one motion compensation interpolation filter and a reference block, decode the block based at least on the prediction block.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for encoding or decoding video data according to the methods described above. One or more embodiments also provide a computer readable storage medium having stored thereon a bitstream generated according to the methods described above. One or more embodiments also provide a method and apparatus for transmitting or receiving the bitstream generated according to the methods described above.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4 illustrates control points based affine motion model, for a 4-parameter affine model on the left and a 6-parameter affine model on the right.

FIG. 5 illustrates an affine motion vector field per subblock.

FIG. 6 illustrates spatial neighboring blocks used in the subblock temporal motion vector prediction mode in VVC (SbTMVP).

FIG. 7 illustrates an example of deriving a sub-CU (sub coding unit) motion field by applying a motion shift from spatial neighbor and scaling the motion information from the corresponding collocated sub-CUs in the SbTMVP mode.

FIG. 8 illustrates an example of frequency responses of a 12-tap interpolation filter (proposed) and the VVC interpolation filter at half-pel phase.

FIG. 9 illustrates an example of a method for encoding a block of a video according to an embodiment.

FIG. 10 illustrates an example of a method for decoding a block of a video according to an embodiment.

FIG. 11 illustrates examples of subblock location in a coding unit (CU)

FIG. 12 illustrates an example of a method for MCIF selection based on motion difference, according to an embodiment.

FIG. 13 illustrates an example of a method for MCIF selection based on coding mode of neighbor blocks, according to an embodiment.

FIG. 14 illustrates an example of a method for MCIF selection based on a 4-parameter affine model conditions, according to an embodiment.

FIG. 15 illustrates an example of a creation of an asymmetric filter with left part of the filter shorter than right part of the filter, according to an embodiment.

FIG. 16 illustrates an example of a creation of an asymmetric filter with right part of the filter shorter than left part of the filter, according to an embodiment.

FIG. 17 illustrates an example of a method for asymmetric filter selection, according to an embodiment.

FIG. 18 shows two remote devices communicating over a communication network in accordance with an example of the present principles.

FIG. 19 shows the syntax of a signal in accordance with an example of the present principles.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

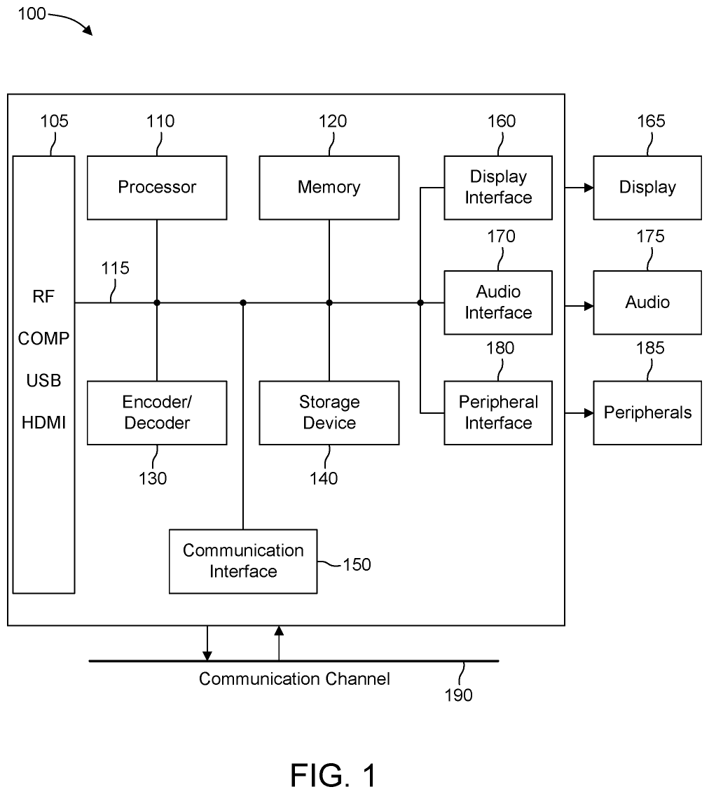

The aspects described and contemplated in this application can be implemented in many different forms. FIGS. 1, 2 and 3 below provide some embodiments, but other embodiments are contemplated and the discussion of FIGS. 1, 2 and 3 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner.

Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

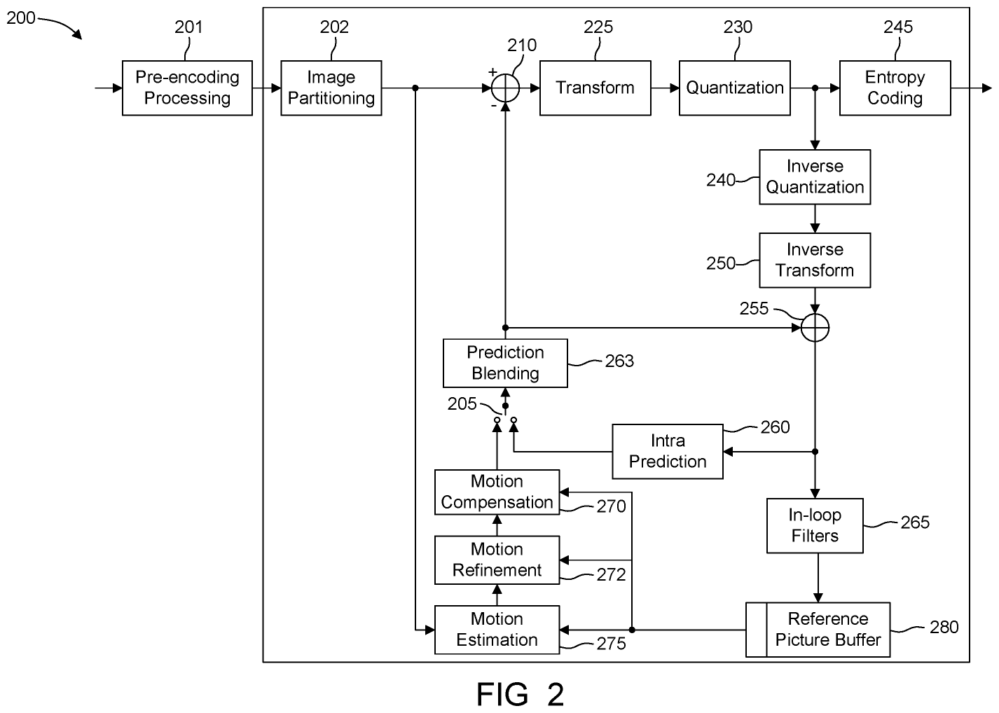

FIG. 2 illustrates an example of a block-based hybrid video encoder 200. Variations of this encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of color components), or re-sizing the picture (ex: down-scaling). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. The encoder may also blend (263) intra prediction result and inter prediction result, or blend results from different intra/inter prediction methods. Prediction residuals are calculated, for example, by subtracting (210) the predicted block from the original image block.

The motion refinement module (272) uses already available reference picture in order to refine the motion field of a block without reference to the original block. A motion field for a region can be considered as a collection of motion vectors for all pixels with the region. If the motion vectors are sub-block-based, the motion field can also be represented as the collection of all sub-block motion vectors in the region (all pixels within a sub-block has the same motion vector, and the motion vectors may vary from sub-block to sub-block). If a single motion vector is used for the region, the motion field for the region can also be represented by the single motion vector (same motion vectors for all pixels in the region).

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

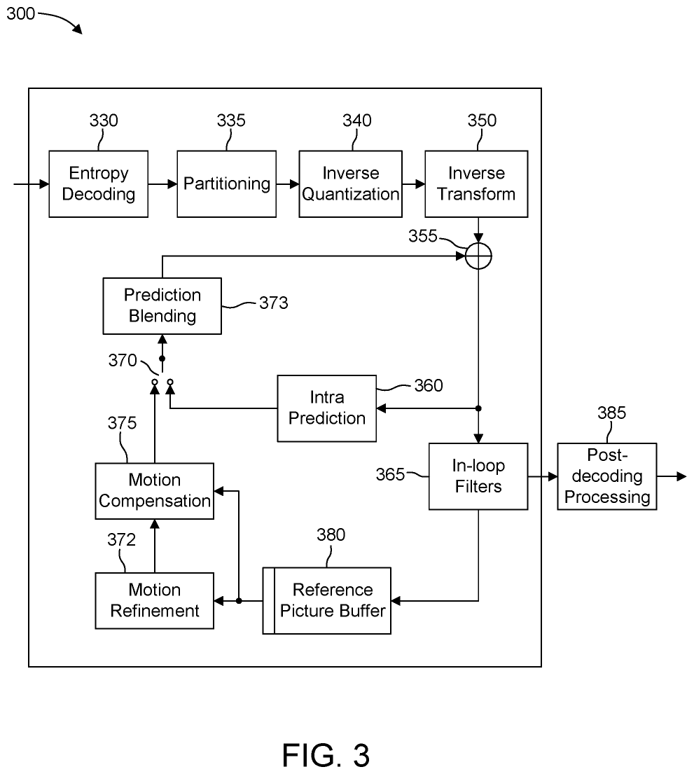

FIG. 3 illustrates a block diagram of a video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed.

The predicted block can be obtained (370) from intra prediction (360) or motion-compensated prediction (i.e., inter prediction) (375). The decoder may blend (373) the intra prediction result and inter prediction result, or blend results from multiple intra/inter prediction methods. Before motion compensation, the motion field may be refined (372) by using already available reference pictures. In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201), or re-sizing the reconstructed pictures (ex: up-scaling). The post-decoding processing can use metadata derived in the pre-encoding processing and signaled in the bitstream.

In some embodiments, FIG. 2 and FIG. 3 also illustrate an encoder/decoder in which improvements are made to the HEVC or VVC standard or an encoder employing technologies similar to VVC, such as an encoder under development by JVET (Joint Video Exploration Team). Various methods and other aspects described in this application can be used to modify modules, for example, the motion compensation module (270) of the video encoder 200 as shown in FIG. 2 and the motion compensation module (375) of the video decoder 300 as shown in FIG. 3. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Inter prediction is a coding tool in video compression that uses reference pictures of the video for predicting a current block of a current picture to encode/decode. The encoder selects the best block in a reference frame after applying a motion model (e.g. Translational or sub-block based motion warping). The best block can be understood for example in rate/distortion sense for predicting a current block. In the following, this selected block is called a reference block.

In current video codec like VVC, 2 types of motion compensation (MC) filters are available: an 8-tap filter based on DCT-IF and a smoother filter for ½ MC. In new video codec software, even larger MC filters are used (e.g. 12-tap filters).

Some video codec also proposes several filters (for example normal, smooth and sharp), possibly combined for horizontal and vertical directions.

In recent codecs, MC filters are becoming longer, increasing the accuracy of the reconstruction. However, in some cases, longer filters are not desirable: for example, when the filter is taking samples from another moving area.

### High Precision ( 1/16 Pel) Motion Compensation and Motion Vector Storage

VVC increases the MV precision to 1/16 luma sample, to improve the prediction efficiency of slow-motion video. This higher motion accuracy is particularly helpful for video contents with locally varying and non-translational motion such as in case of affine mode (warping). For fractional position samples generation of higher MV accuracy, HEVC's 8-tap luma interpolation filters and 4-tap chroma interpolation filters have been extended to 16 phases for luma and 32 phases for chroma. This extended filter set is applied in MC process of inter coded CUs (coding units) except the CUs in affine mode. For affine mode, a set of 6-tap luma interpolation filter with 16 phases is used for lower computational complexity as well as memory bandwidth saving.

In VVC, the highest precision of explicitly signalled motion vectors for non-affine CU is quarter-luma-sample. In some inter prediction modes such as the affine mode, motion vectors can be signalled at 1/16-luma-sample precision. In all inter coded CU with implicitly inferred MVs, the MVs are derived at 1/16-luma-sample precision and motion compensated prediction is performed at 1/16-sample-precision. In terms of internal motion field storage, all motion vectors are stored at 1/16-luma-sample precision.

For temporal motion field storage used by TMVP (temporal motion vector prediction) and SbTMVP (subblock temporal motion vector prediction), motion field compression is performed at 8×8 size granularity in contrast to the 16×16 size granularity in HEVC.

### Affine Motion Compensated Prediction

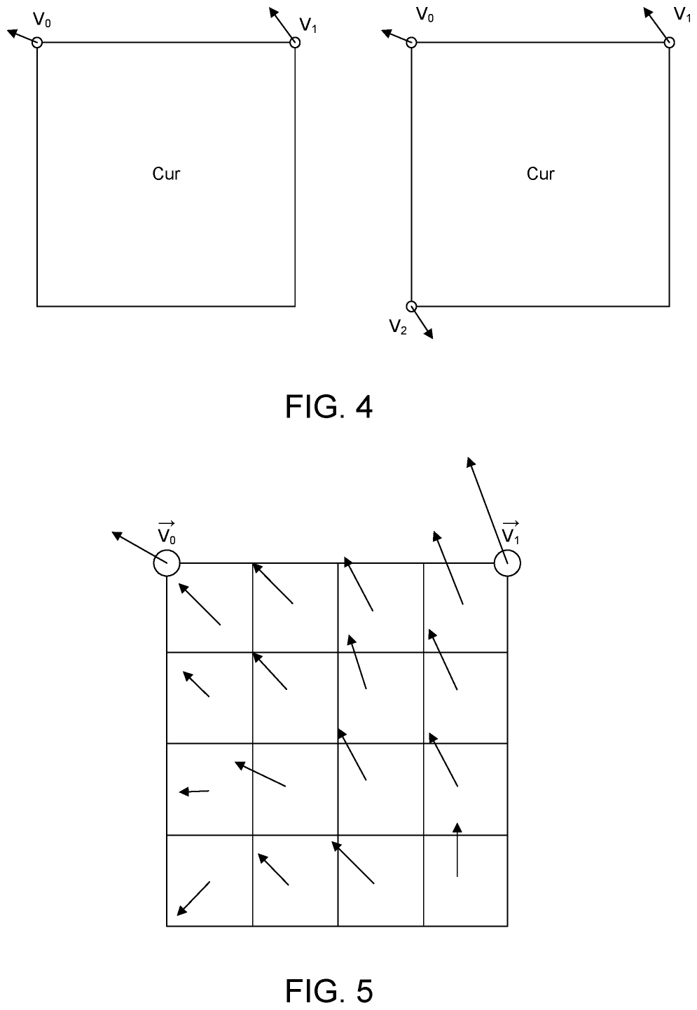

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction allows to perform warping with motion compensation. As shown in FIG. 4, the affine motion field of the block is described by motion information of two control points (4-parameter affine model shown on the left part) or three control point motion vectors (6-parameter affine model shown on the right part).

For 4-parameter affine motion model, the motion vector (mvₓ, mv_{y}) at sample location (x, y) in a block (Cur) is derived as:

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix}$$

For 6-parameter affine motion model, motion vector at sample location (x, y) in a block (Cur) is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix}$$

Where (mv₀ₓ, mv_{0y}) is the motion vector of the top-left corner control point v₀, (mv₁ₓ, mv_{1y}) is the motion vector of the top-right corner control point v₁, and (mv₂ₓ, mv_{2y}) is the motion vector of the bottom-left corner control point v₂, and H and W are the block size (height and width).

In order to simplify the motion compensation prediction, block based affine transform prediction is applied. To derive motion vector of each 4×4 luma subblock, the motion vector of the center sample of each subblock, as shown in FIG. 5, is calculated according to the above equations, and rounded to 1/16 fraction accuracy. Then the motion compensation interpolation filters are applied to generate the prediction of each subblock with the derived motion vector. The subblock size of chroma-components is also set to be 4×4. The MV of a 4×4 chroma subblock is calculated as the average of the MVs of the top-left and bottom-right luma subblocks in the collocated 8×8 luma region.

As done for translational motion inter prediction, there are also two affine motion inter prediction modes: affine merge mode and affine AMVP (advanced motion vector prediction) mode.

### Subblock-Based Temporal Motion Vector Prediction (SbTMVP)

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTVMP. SbTMVP differs from TMVP in the following aspects. TMVP predicts motion at CU level but SbTMVP predicts motion at sub-CU level. Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

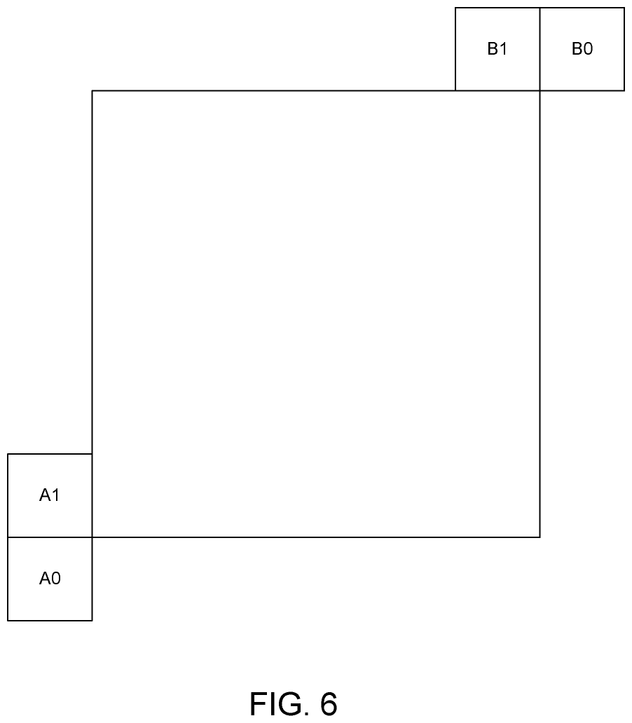

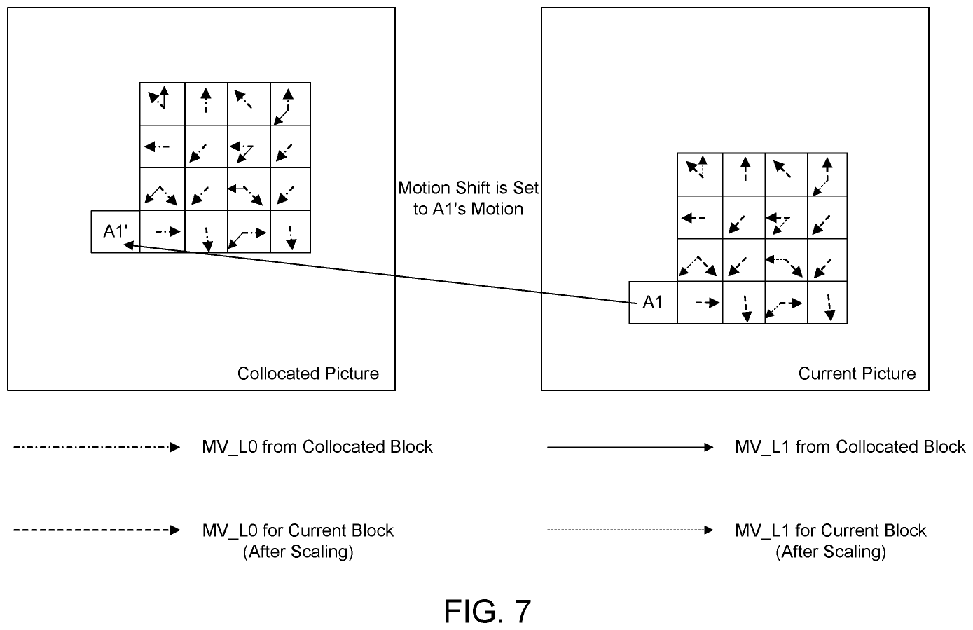

The SbTMVP process is illustrated in FIGS. 6 and 7. SbTMVP predicts the motion vectors of the sub-CUs within the current CU in two steps. In the first step, the spatial neighbor A1 in FIG. 6 is examined. If A1 has a motion vector that uses the collocated picture as its reference picture, this motion vector is selected to be the motion shift to be applied. If no such motion is identified, then the motion shift is set to (0, 0).

In the second step, the motion shift identified in the first step is applied (i.e. added to the current block's coordinates) to obtain sub-CU level motion information (motion vectors and reference indices) from the collocated picture as shown in FIG. 7. The example in FIG. 7 assumes the motion shift is set to block A1's motion. Then, for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU.

In VVC, a combined subblock based merge list which contains both SbTMVP candidate and affine merge candidates is used for the signalling of subblock based merge mode. The SbTMVP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for affine merge mode, SbTMVP mode is only applicable to the CU with both width and height are larger than or equal to 8.

The encoding logic of the additional SbTMVP merge candidate is the same as for the other merge candidates, that is, for each CU in P or B slice, an additional RD check is performed to decide whether to use the SbTMVP candidate.

### Interpolation Filter in VVC

Table 1 below shows the specification of the 8-taps luma interpolation filter coefficients f_{L}[p] for each 1/16 fractional sample position p.

TABLE 1

| Fractional | | | | | | | | |
|---|---|---|---|---|---|---|---|---|
| sample | interpolation filter coefficients | | | | | | | |
| position p | f_{L}[p][0] | f_{L}[p][1] | f_{L}[p][2] | f_{L}[p][3] | f_{L}[p][4] | f_{L}[p][5] | f_{L}[p][6] | f_{L}[p][7] |
| 1 | 0 | 1 | −3 | 63 | 4 | −2 | 1 | 0 |
| 2 | −1 | 2 | −5 | 62 | 8 | −3 | 1 | 0 |
| 3 | −1 | 3 | −8 | 60 | 13 | −4 | 1 | 0 |
| 4 | −1 | 4 | −10 | 58 | 17 | −5 | 1 | 0 |
| 5 | −1 | 4 | −11 | 52 | 26 | −8 | 3 | −1 |
| 6 | −1 | 3 | −9 | 47 | 31 | −10 | 4 | −1 |
| 7 | −1 | 4 | −11 | 45 | 34 | −10 | 4 | −1 |
| 8 (hpellfIdx == 0) | −1 | 4 | −11 | 40 | 40 | −11 | 4 | −1 |
| 8 (hpellfIdx == 1) | 0 | 3 | 9 | 20 | 20 | 9 | 3 | 0 |
| 9 | −1 | 4 | −10 | 34 | 45 | −11 | 4 | −1 |
| 10 | −1 | 4 | −10 | 31 | 47 | −9 | 3 | −1 |
| 11 | −1 | 3 | −8 | 26 | 52 | −11 | 4 | −1 |
| 12 | 0 | 1 | −5 | 17 | 58 | −10 | 4 | −1 |
| 13 | 0 | 1 | −4 | 13 | 60 | −8 | 3 | −1 |
| 14 | 0 | 1 | −3 | 8 | 62 | −5 | 2 | −1 |
| 15 | 0 | 1 | −2 | 4 | 63 | −3 | 1 | 0 |

### Interpolation Filter in ECM Software

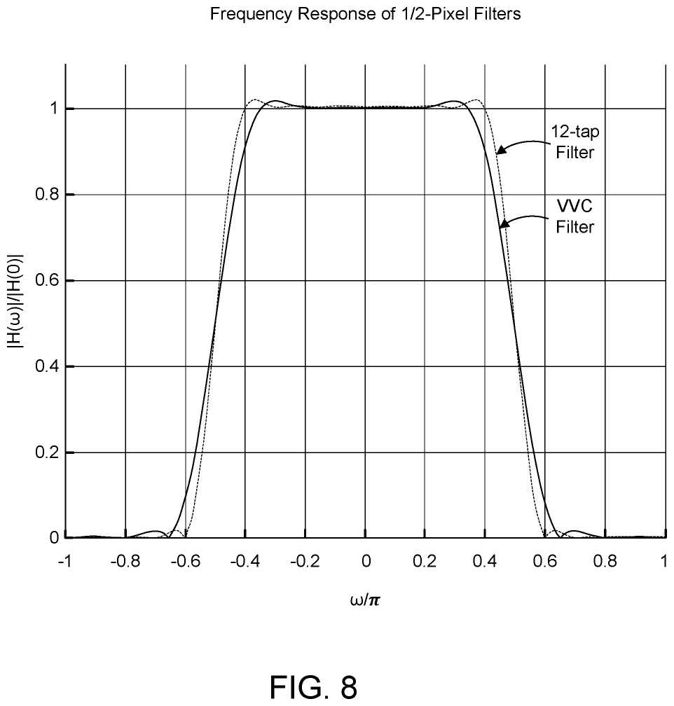

In the ECM software, the 8-tap interpolation filter used in VVC is replaced with a 12-tap filter. The interpolation filter is derived from the sinc function of which the frequency response is cut off at Nyquist frequency, and cropped by a cosine window function. Table 2 below gives the filter coefficients of all 16 phases for the 12-tap interpolation filter. FIG. 8 compares the frequency responses of the interpolation filters with the VVC interpolation filter, all at half-pel phase.

TABLE 2

| | | | | | | | | | | | | |
|---|---|---|---|---|---|---|---|---|---|---|---|---|
| 1/16 | −1 | 2 | −3 | 6 | −14 | 254 | 16 | −7 | 4 | −2 | 1 | 0 |
| 2/16 | −1 | 3 | −7 | 12 | −26 | 249 | 35 | −15 | 8 | −4 | 2 | 0 |
| 3/16 | −2 | 5 | −9 | 17 | −36 | 241 | 54 | −22 | 12 | −6 | 3 | −1 |
| 4/16 | −2 | 5 | −11 | 21 | −43 | 230 | 75 | −29 | 15 | −8 | 4 | −1 |
| 5/16 | −2 | 6 | −13 | 24 | −48 | 216 | 97 | −36 | 19 | −10 | 4 | −1 |
| 6/16 | −2 | 7 | −14 | 25 | −51 | 200 | 119 | −42 | 22 | −12 | 5 | −1 |
| 7/16 | −2 | 7 | −14 | 26 | −51 | 181 | 140 | −46 | 24 | −13 | 6 | −2 |
| 8/16 | −2 | 6 | −13 | 25 | −50 | 162 | 162 | −50 | 25 | −13 | 6 | −2 |
| 9/16 | −2 | 6 | −13 | 24 | −46 | 140 | 181 | −51 | 26 | −14 | 7 | −2 |
| 10/16 | −1 | 5 | −12 | 22 | −42 | 119 | 200 | −51 | 25 | −14 | 7 | −2 |
| 11/16 | −1 | 4 | −10 | 19 | −36 | 97 | 216 | −48 | 24 | −13 | 6 | −2 |
| 12/16 | −1 | 4 | −8 | 15 | −29 | 75 | 230 | −43 | 21 | −11 | 5 | −2 |
| 13/16 | −1 | 3 | −6 | 12 | −22 | 54 | 241 | −36 | 17 | −9 | 5 | −2 |
| 14/16 | 0 | 2 | −4 | 8 | −15 | 35 | 249 | −26 | 12 | −7 | 3 | −1 |
| 15/16 | 0 | 1 | −2 | 4 | −7 | 16 | 254 | −14 | 6 | −3 | 2 | −1 |

According to an aspect of the present principles, a method for encoding or decoding a video is provided wherein adapted motion compensation filter is used for inter-prediction.

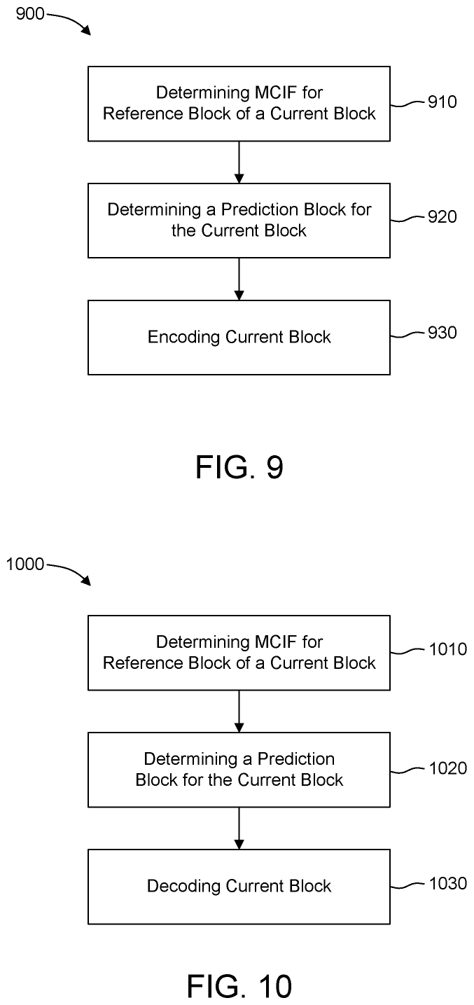

FIG. 9 illustrates an example of a method 900 for encoding a block of a video according to an embodiment. The block is to be encoded using inter-prediction for instance using the encoder described in relation with FIG. 2. It is assumed here that a reference block is already identified for the current block to encode. A reference block is a block area in the reference picture that is used by the current block to encode, the block area in the reference picture being determined by the motion vector associated to the current block.

At 910, a motion compensation interpolation filter (MCIF) is determined for the current block. In some variants, when the MCIF is separable, horizontal MCIF and vertical MCIF are determined separately. Some embodiments are described below for determining the MCIF for the current block. In some embodiments, the MICF is adapted according to the current block discontinuities conditions. At 920, a prediction block is determined based on the determined MCIF and the reference block from the reference picture. The reference block is interpolated using the determined MCIF to provide the prediction block. At 930, the current block is encoded using the prediction block.

FIG. 10 illustrates an example of a method 1000 for decoding a block of a video according to an embodiment. The block is encoded using inter-prediction and is for instance decoded using the decoder described in reference to FIG. 3. In a similar manner as for the encoder, at 1010, a MCIF is determined for the block to decode. At 1020, a prediction block is determined based on the determined MCIF and the reference block and at 1030, the current block is decoded/reconstructed using the prediction block.

According to the present principles, in order to improve the inter prediction, motion compensation interpolation filters (MCIF) are adapted based on discontinuities conditions described below. According to a variant, at 910 of FIG. 9 or 1010 of FIG. 10, the length of the MCIF is adapted. For instance, this can be done by selecting a MCIF among a set of filters having different length, such as the 8-tap filter of VVC and the 12-tap filter of ECM. However, other variants and filters are possible.

In other variants, the response of the filter is adapted, typically using smoother alternative filters for sub-blocks at discontinuities location.

### Location-Based Selection

According to an embodiment, selecting a MCIF is based on a location of the block in an area larger than the block. When the block is a subblock of a larger block or coding unit (CU) having a plurality of subblocks, the selection of the MCIF is based on the location of the subblock in the coding unit.

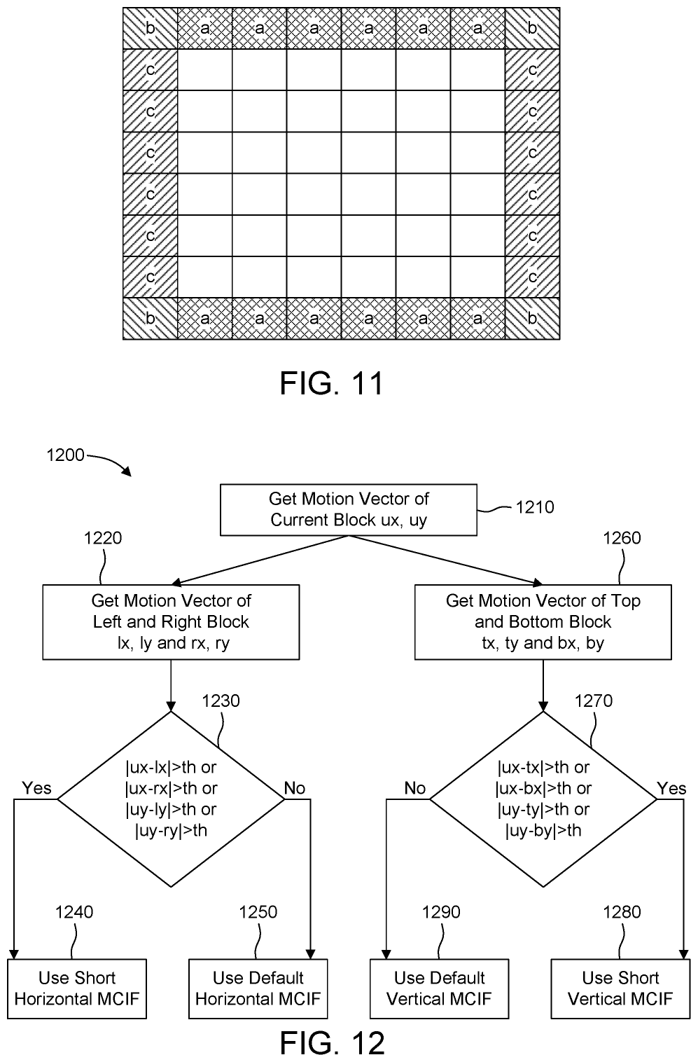

FIG. 11 illustrates a 32×32 CU composed of 4×4 sub-blocks. Subblocks are assumed to be the unit entity for motion compensation. In this embodiment, the filter used for motion compensation is adapted depending on the sub-block location. For center sub-block (white square on FIG. 11), the default filters are used, for instance a N-tap filter, N being an integer. For sub-blocks “a”, as vertical filtering takes samples outside the CU, likely in areas not of the same “object”, vertical filtering uses shorter filter, for instance a M-tap filter, M being an integer with M<N. Horizontal filters are the default filters (N-tap filter). For sub-blocks in “c”, this is the opposite: horizontal filters are shorter (M-tap) and vertical filters are the default ones (N-tap). For sub-blocks in “b”, both horizontal and vertical are shorter than the default ones.

As an example, default filters are the 12-taps filters described above and the shorter ones are the 8-tap filters. Other filters can be used.

In this embodiment, when the block is located at an inner boundary of the coding unit, at least one of the horizontal MCIF or vertical MCIF has a length shorter than the MCIF used for the block when the block is inside the coding unit and not at an inner boundary of the coding unit, (i.e. when the block is a white subblock in FIG. 11).

In FIG. 11, the inner boundary has a one-subblock width. In other variants, the inner boundary can be thicker and have a width of more than one subblock. In this variant, the band where MCIF are shorter is more than 1 sub-block.

In another variant, several short filters are used and the filters become shorter when close to the boundary of the block in one or both directions. In this variant, the length of at least one of the horizontal MCIF or the vertical MCIF varies with the distance of the block to the center of the coding unit.

### Motion-Based Filter Selection

In another embodiment, the MCIF is selected based on a motion difference between motion of the block and motion of at least one of a horizontal and a vertical neighbor of the block.

In this embodiment, the concept is generalized to any 4×4 sub-blocks, based on the motion difference with its sub-block neighbors as illustrated with FIG. 12.

Depending on the motion difference with its horizontal (respectively vertical) neighbors, the length of the filter is adapted. When no motion is available, the motion difference is assumed to be null. Method 1200 is an example of a method for MCIF selection based on motion difference between motion of the block and neighboring blocks. At 1210, the motion vector (ux, uy) of the current block is obtained. At 1220, the motion vector (lx, ly) of the block at the left of the block is obtained and the motion vector (rx, ry) of the block at the right of the block is obtained if available. At 1230, the difference between the motion vectors of the current block and its neighbors are compared with a threshold th, for instance as follows, if |ux-lx| is above the threshold, or if |ux-rx| is above the threshold, or if |uy-ly| is above the threshold or if |uy-ry| is above the threshold, then at 1240, a short MCIF is selected for the horizontal direction. Otherwise, at 1250, a default filter is selected for the horizontal direction. The same logic can be applied for the vertical direction. At 1220, the motion vector (tx, ty) of the block on top of the block and the motion vector (bx, by) of the block at the bottom of the block are obtained if available. At 1270, the difference between the motion vectors are compared with the threshold th. When the difference is above the threshold for at least one of the x or y coordinates, at 1280, a short MCIF is selected for the vertical direction. Otherwise, at 1290, a default filter is selected for the vertical direction.

When no motion is available, for instance for right and bottom blocks, it is considered that the difference is null. In some cases, the motion of right and bottom subblocks is available for subblock inside a coding unit for a coding unit having subblock motion like affine or SbTMVP. For subblock at the right or bottom border of a coding unit, the motion of right and bottom neighbors is not available.

In a variant, for such subblocks (subblock at the right or bottom border of a coding unit), a short filter is always selected.

In a variant, the filter selection is done using neighboring reconstructed pixels of the current block to encode or decode. In this variant, a determination is made to determine whether an edge is present or not in the current block, for instance by applying an edge detection on the neighboring reconstructed pixels of the current block. When it is determined that an edge is present, a filter shorter than a default one is selected for filtering the reference block.

In another variant, all filters are applied to a neighboring template of the current block and a filter that allows a best reconstruction of the neighboring template is selected for the current block.

A filter is considered as a best filter for instance in terms of quality reconstruction provided by the considered filter. Thus, the selection of the filter is this variant is performed by selecting the filter providing a minimum distortion between the pixels of the neighboring template of the current block and the pixels of the neighboring template of the reference block filtered by the considered filter. The neighboring template is for instance a template comprising neighboring reconstructed pixels in a band at the left of the current block and in a band on top of the current block, such as a template from a template matching method for instance.

In a variant, only the sub-blocks at the boundaries of the coding unit uses the embodiments described above. The boundaries may have a width of one or more subblocks.

### Mode-Based Selection

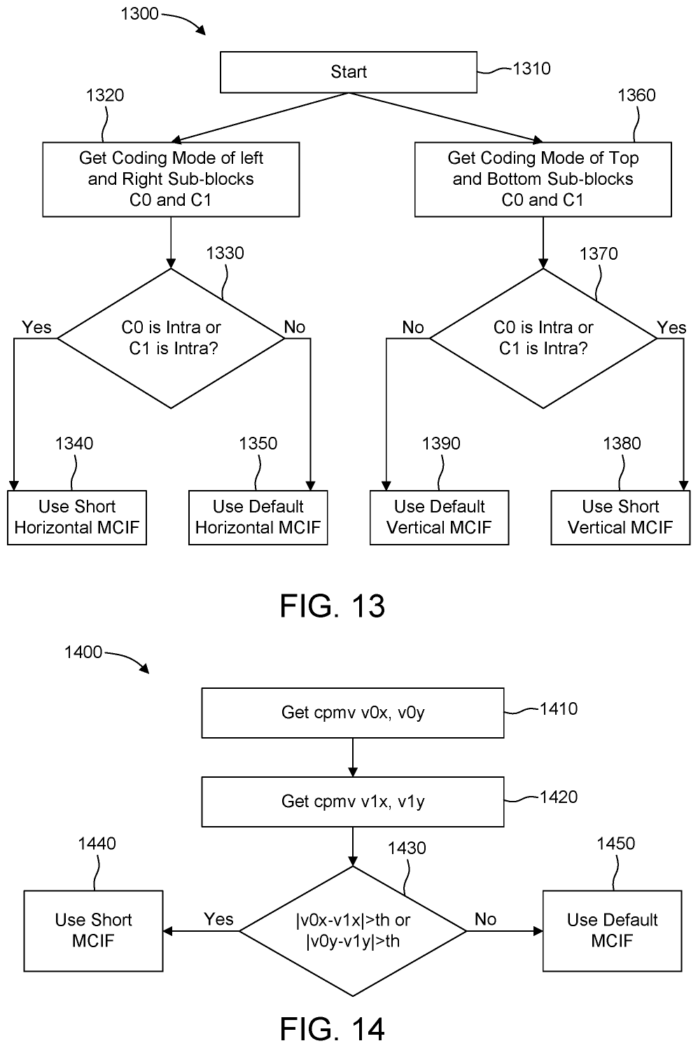

In another embodiment, the MCIF is selected based on a coding mode of at least one of a neighboring block of the block. In this variant, the filter selection is based on the mode of the neighboring (sub-)blocks for instance as illustrated by FIG. 13. The process starts at 1310. At 1320, the coding mode C0 of the left neighbor of the block and the coding mode C1 of the right neighbor of the block are obtained. At 1330, it is determined whether at least one of C0 or C1 is intra coded. When at least one of C0 and C1 is intra coded, at 1340, a short MCIF is selected for the horizontal direction. Otherwise, at 1350, a default filter is selected for the horizontal direction. A same logic can be applied for the vertical direction. At 1360, the coding mode C0 of the top neighbor of the block and the coding mode C1 of the bottom neighbor of the block are obtained. At 1370, it is determined whether at least one of C0 or C1 is intra coded. When at least one of C0 and C1 is intra coded, at 1380, a short MCIF is selected for the vertical direction. Otherwise, at 1390, a default filter is selected for the vertical direction.

In this embodiment, depending on the mode of the neighbors, the length of the filter is adapted. When no mode is available, the mode is supposed to be non intra.

In a variant, other modes are compared, for example the presence of a residual (non-zero transform coefficients) in the neighboring sub-blocks. When a residual is present for a left or right neighboring subblock, a filter shorter than the default one is selected for the horizontal direction. The same logic applied for the vertical direction with the top and bottom neighbor blocks.

In a variant, only sub-block at the block boundaries of the coding unit uses the embodiment described above.

In a variant, a combination of at least two of the above conditions (location, motion, mode) is used to decide the MCIF. In this variant, when at least one the conditions above is true, then a short filter is selected.

### Deblocking Filter Conditions Selection

TABLE 3
Deblocking filter strength derivation for luma samples

| Priority | Conditions | Y | U | V |
|---|---|---|---|---|
| 5 | At least one of the adjacent blocks is intra | 2 | 2 | 2 |
| 4 | At least one of the adjacent blocks has | 1 | 1 | 1 |
| | non-zero transform coefficients | | | |
| 3 | Absolute difference between the motion | 1 | N/A | N/A |
| | vectors that belong to the adjacent blocks | | | |
| | is greater than or equal to one half luma sample | | | |
| 2 | Motion prediction in the adjacent blocks | 1 | N/A | N/A |
| | refers to different reference frames | | | |
| 1 | Otherwise | 0 | 0 | 0 |

Table 3 above shows the deblocking filter strength derivation for luma samples.

In this embodiment, the same logic is re-used for selecting the MCIF for the block. The conditions to select a filter shorter than the default one can be deduced from at least one of: whether the neighbor block is intra coded or not, or whether an adjacent block has a residual (i.e. non-zero transform coefficients), or motion vectors of the current block and its neighbors are different, Reference pictures of the current block and its neighbors are different.

A short filter can be selected when at least one of the conditions is met.

### Affine Model-Based Selection

According to another embodiment, the MCIF is selected based on a motion difference between control motion vectors when the block is coded in an affine model-based coding mode

For affine inter prediction, the filters to use for each sub-block depends on the amplitude of the non-translational part of the motion. When the non-translational part has a large amplitude, motion difference between each sub-block is larger. Instead of testing the motion difference between each sub-block of the affine block, a test is performed for the whole block based on the motion model encoded in the CPMV (v0,v1) for the affine 4-parameter model or (v0,v1,v2) for the affine 6-parameter model as shown in FIG. 14. FIG. 14 illustrates an example of a method 1400 for MCIF selection based on a 4-parameter affine model conditions, according to an embodiment. At 1410 and 1420, the top left, respectively top right, control motion vector (v0x, v0y), respectively (v1x, v1y), of the block is obtained. At 1430, the amplitude of the between the control point motion vectors is checked against a threshold th. When the amplitude is above the threshold for at least one of the coordinates, then at 1440, a short MCIF is selected, otherwise at 1450, a default MCIF is used.

The same logic can also be applied to the control point motion vector cpmv v2 when available for the 6-parameter affine motion model.

In a variant, the non-default MCIF selected at 1440 is a smoother filter rather than a shorter filter.

In a variant, only the sub-blocks on the boundaries of the coding unit use the above embodiment.

### Asymmetric MCIF

In another embodiment, the MCIF is adapted more specifically to the discontinuities location by taking into account not only the direction (horizontal or vertical) but also the left/right (or top/bottom) discontinuities.

In the embodiment, at 910 of FIG. 9 or at 1010 of FIG. 10, the MCIF is determined for the block by creating a new MCIF from two filters having different lengths.

### Example for a Phase 1/16 Filter

In the following, an example of asymmetric filter construction using an 8-tap filter and 12-tap filter is described. This example is for illustrative purposes of the present principle. Other filters with same or other lengths can also be used.

TABLE 4

| | | | | | | | | | | | |
|---|---|---|---|---|---|---|---|---|---|---|---|
| 0 | 0 | 0 | 1*4 | −3*4 | 63*4 | 4*4 | −2*4 | 1*4 | 0 | 0 | 0 |
| −1 | 2 | −3 | 6 | −14 | 254 | 16 | −7 | 4 | −2 | 1 | 0 |

The table 4 above gives an example of 8-tap (top raw) and 12-tap (bottom raw) filtering for phase 1/16 MCIF, using the same scaling.

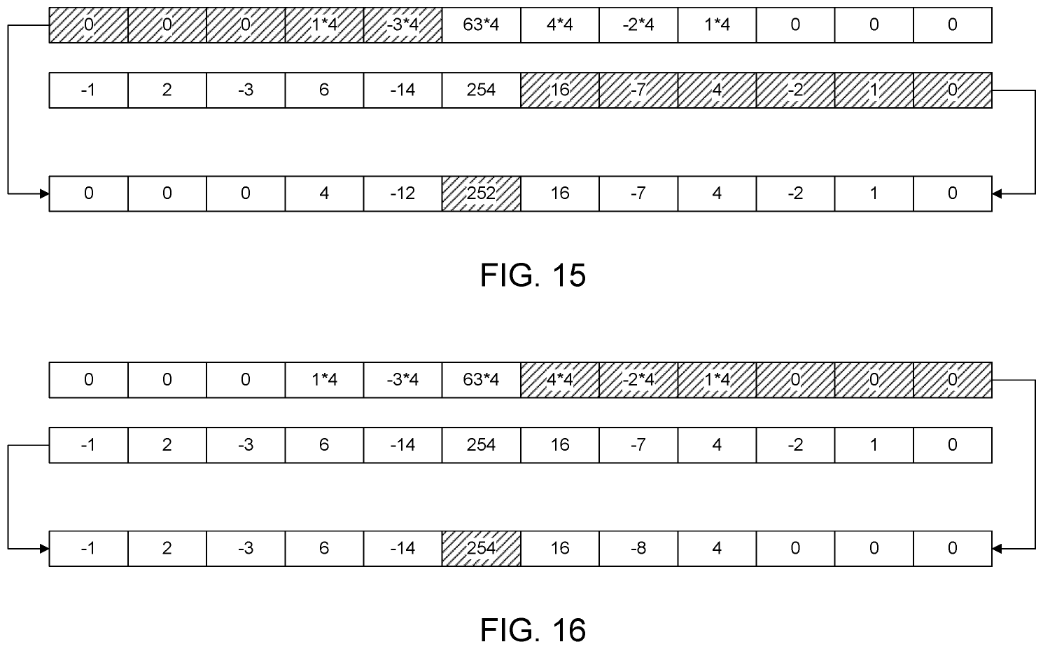

In order to create a filter with shorter left part, the 2 filters are concatenated, using the short filter for the left part and the long filter for the right part (see FIG. 15). The central coefficient is adjusted to get a unit filter (sum of all coefficients should be 1, here 256 after quantization).

The same logic applies to create a filter with a shorter right part as shown in FIG. 16.

### Asymmetric Filter Usage

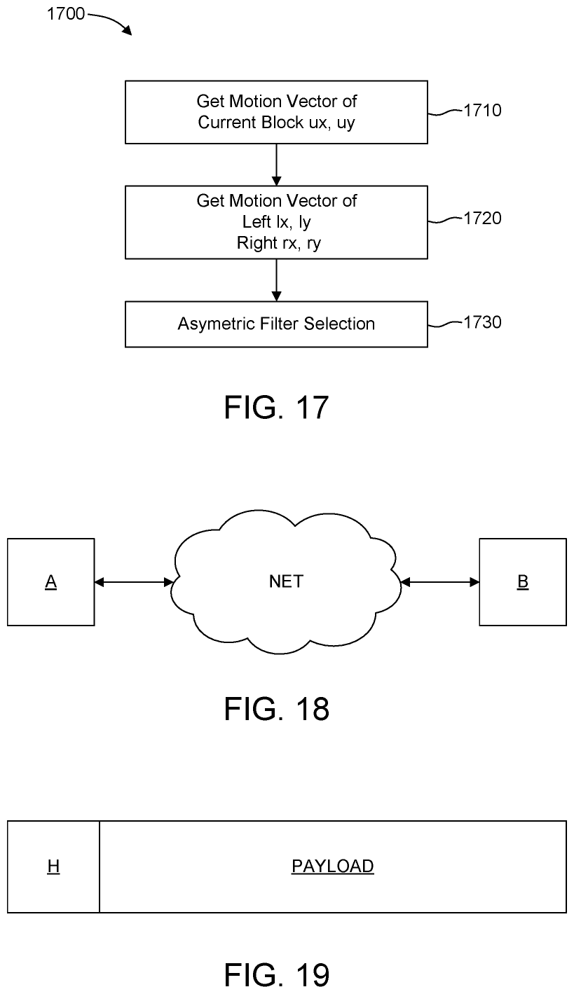

In FIG. 17, an example of a method 1700 for horizontal filter selection is provided.

At 1710, the motion vector (ux, uy) of the current block is obtained. At 1720, the motion vector (lx, ly) of the block at the left of the current block and the motion vector (rx, ry) of the block at the right of the current are obtained. At 1730, the asymmetric filter is selected based on the conditions Provided in table 5 below.

TABLE 5
examples of asymmetric filter selection conditions

| | \|ux-lx\| > th or | \|ux-rx\| > th |
|---|---|---|
| | \|uy-ly\| > th | or \|uy-ry\| > th |
| Long | False | False |
| Long left, short right | False | True |
| Short left, long right | True | False |
| Short | True | True |

The conditions (|ux-lx|> th or |uy-ly|>th) to check are shown in the first raw of table 5. As shown on table 5, when both conditions are false, a long or default filter is selected for the block. When both conditions are true, a short filter is selected. Otherwise, an asymmetric filter is selected, with the left or right part shorter than the other part depending on the conditions.

The same logic as illustrated with FIG. 17 and table 5 applies for vertical filter selecting, by checking top and bottom sub-blocks rather than left and right.

The same logic also extends to other conditions for filter selection.

### Syntax

At CU/region/slice/picture/sequence level, a flag (sps_adapted_mcif) may be coded to signal if the adapted filters are used. It may be inherited at CU level possibly too. The table below shows examples of syntax for signaling whether any one of the embodiments allowing to use an adapted MICF is enabled or not.

Sequence parameter set RBSP syntax

| | Descriptor |
|---|---|
| seq_parameter_set_rbsp( ) { | |
| sps_seq_parameter_set_id | u(4) |
| sps_video_parameter_set_id | u(4) |
| sps_max_sublayers_minus1 | u(3) |
| sps_chroma_format_idc | u(2) |
| sps_log2_ctu_size_minus5 | u(2) |
| sps_ptl_dpb_hrd_params_present_flag | u(1) |
| if( sps_ptl_dpb_hrd_params_present_flag ) | |
| profile_tier_level( 1, sps_max_sublayers_minus1 ) | |
| sps_adapted_mcif | u(1) |

Slice header syntax

| | Descriptor |
|---|---|
| slice_header( ) { | |
| sh_picture_header_in_slice_header_flag | u(1) |
| ... | |
| if( sh_slice_type != l && sps_adapted_mcif) | |
| sh_adapted_mcif | u(1) |

In the slice header of non intra slice, a flag (sh_adapted_mcif) controlling the use of the tool is signaled.

In an embodiment, illustrated in FIG. 18, in a transmission context between two remote devices A and B over a communication network NET, the device A comprises a processor in relation with memory RAM and ROM which are configured to implement a method for encoding a video as described with FIG. 1-17 and the device B comprises a processor in relation with memory RAM and ROM which are configured to implement a method for decoding a video as described in relation with FIGS. 1-17.

In accordance with an example, the network is a broadcast network, adapted to broadcast/transmit encoded data representative of a video from device A to decoding devices including the device B.

A signal, intended to be transmitted by the device A, carries at least one bitstream comprising coded data representative of a video. The bitstream may be generated from any embodiments of the present principles.

FIG. 19 shows an example of the syntax of such a signal transmitted over a packet-based transmission protocol. Each transmitted packet P comprises a header H and a payload PAYLOAD. In some embodiments, the payload PAYLOAD may comprise coded video data encoded according to any one of the embodiments described above.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, decode re-sampling filter coefficients, re-sampling a decoded picture.

As further examples, in one embodiment “decoding” refers only to entropy decoding, in another embodiment “decoding” refers only to differential decoding, and in another embodiment “decoding” refers to a combination of entropy decoding and differential decoding, and in another embodiment “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining re-sampling filter coefficients, re-sampling a decoded picture.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, are descriptive terms. As such, they do not preclude the use of other syntax element names.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated to a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process. Some embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of re-sampling filter coefficients. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments is described herein. Features of these embodiments can be provided alone or in any combination, across various claim categories and types. Further, embodiments can include one or more of the following features, devices, or aspects, alone or in any combination, across various claim categories and types:
Encoding/decoding a video that comprises adapting a motion compensation interpolation filter based on discontinuities conditions of the block.
Encoding/decoding a block of a video that comprises adapting a motion compensation interpolation filter based on a location of the block in the coding unit.
Encoding/decoding a block of a video that comprises adapting a motion compensation interpolation filter based on motion difference between motion of the block and its neighbor blocks.
Encoding/decoding a block of a video that comprises adapting a motion compensation interpolation filter based on coding modes of neighbors of the block.
Encoding/decoding a block of a video that comprises adapting a motion compensation interpolation filter based on neighboring reconstructing pixels of the block.
Encoding/decoding a block of a video that comprises adapting a motion compensation interpolation filter based on motion difference between control motion vectors when the block is coded in an affine model-based coding mode.
Encoding/decoding a block of a video that comprises creating an asymmetric motion compensation interpolation filter based on discontinuities conditions of the block.
Encoding/decoding a block of a video that comprises creating an asymmetric motion compensation interpolation filter from two filter having different length.
Encoding/decoding a video that comprises responsive to a determination that the block is at the boundaries of a coding unit, adapting a motion compensation interpolation filter based on discontinuities conditions of the block.
Encoding/decoding a video that comprises responsive to a determination that the block is at the boundaries of a coding unit, creating an asymmetric motion compensation interpolation filter based on discontinuities conditions of the block.
Encoding/decoding a video that comprises signaling an information enabling/disabling a use of adapted motion compensation interpolation filters.
A bitstream or signal that includes one or more of the described syntax elements, or variations thereof.
A bitstream or signal that includes syntax conveying information generated according to any of the embodiments described.
Creating and/or transmitting and/or receiving and/or decoding a bitstream or signal that includes one or more of the described syntax elements, or variations thereof.
Creating and/or transmitting and/or receiving and/or decoding according to any of the embodiments described.
A method, process, apparatus, medium storing instructions, medium storing data, or signal according to any of the embodiments described.
A TV, set-top box, cell phone, tablet, or other electronic device that performs decoding of a video according to any of the embodiments described.
A TV, set-top box, cell phone, tablet, or other electronic device that performs decoding of a video according to any of the embodiments described, and that displays (e.g. using a monitor, screen, or other type of display) a resulting video.
A TV, set-top box, cell phone, tablet, or other electronic device that selects (e.g. using a tuner) a channel to receive a signal including an encoded video, and performs decoding of the video according to any of the embodiments described.
A TV, set-top box, cell phone, tablet, or other electronic device that receives (e.g. using an antenna) a signal over the air that includes an encoded video, and performs decoding of the video according to any of the embodiments described.

1. A method comprising decoding a block of a coding unit of a video, the coding unit having a plurality of blocks, the method includes:
determining at least one motion compensation interpolation filter for the block from a set of motion compensation interpolation filters having different length, wherein a length of the determined motion compensation interpolation filter depends on a location of the block in the coding unit,
determining a prediction block based on the at least one motion compensation interpolation filter and a reference block, and
decoding the block based at least on the prediction block.

2. An apparatus, comprising one or more processors, wherein said one or more processors are configured to decode a block of a coding unit of a video, the coding unit having a plurality of blocks, wherein decoding the block comprises:
determining at least one motion compensation interpolation filter for the block from a set of motion compensation interpolation filters having different length, wherein a length of the determined motion compensation interpolation filter depends on a location of the block in the coding unit,
determining a prediction block based on the at least one motion compensation interpolation filter and a reference block, and
decoding the block based at least on the prediction block.

3. A method comprising encoding a block of a coding unit of a video, the coding unit having a plurality of blocks, the method including:
determining at least one motion compensation interpolation filter for the block from a set of motion compensation interpolation filters having different length, wherein a length of the determined motion compensation interpolation depends on a location of the block in the coding unit,
determining a prediction block based on the at least one motion compensation interpolation filter and a reference block, and
encoding the block based at least on the prediction block.

4. An apparatus, comprising one or more processors, wherein said one or more processors are configured to encode a block of a coding unit of a video, the coding unit having a plurality of blocks, wherein encoding the block comprises:
determining at least one motion compensation interpolation filter for the block from a set of motion compensation interpolation filters having different length, wherein a length of the determined motion compensation interpolation filter depends on a location of the block in the coding unit,
determining a prediction block based on the at least one motion compensation interpolation filter and a reference block, and
encoding the block based at least on the prediction block.

5-6. (canceled)

7. The method of claim 1, wherein determining the at least one motion compensation interpolation filter comprises selecting the at least one motion compensation interpolation filter from the set of motion compensation interpolation filters.

8. The method claim 1, wherein, selecting the at least one motion compensation interpolation filter comprises:
selecting a horizontal motion compensation interpolation filter for filtering the reference block in an horizontal direction, and
selecting a vertical motion compensation interpolation filter for filtering the reference block in a vertical direction.

9. The method of claim 8, wherein, when the block is located at an inner boundary of the coding unit, at least one of the horizontal motion compensation interpolation filter or vertical motion compensation interpolation filter has a length shorter than the motion compensation interpolation filter selected for the block when the block is inside the coding unit and not at an inner boundary of the coding unit.

10. The method of claim 9, wherein the motion compensation interpolation filter selected for the block when the block is not at an inner boundary of the coding unit is a 12-tap filter.

11. The method of claim 9, wherein at least one of the horizontal motion compensation interpolation filter or vertical motion compensation interpolation filter selected for the block when the block is located at an inner boundary of the coding unit is an 8-tap filter.

12. The method of claims 9-11, wherein the inner boundary of the coding unit is a band having a width of at least one subblock.

13. The method of claim 8, wherein a length of at least one of the horizontal motion compensation interpolation filter or the vertical motion compensation interpolation filter varies with the distance of the block to the center of the coding unit.

14. The method of claim 13, wherein the closer the block is to the center of the coding unit, the shorter the length of the motion compensation interpolation filter is.

15-21. (canceled)

22. The method of claim 1, wherein the motion compensation interpolation filter is selected following a same logic as a deblocking filter logic.

23-29. (canceled)

30. The method of claim 1, further comprising, decoding an information enabling or disabling a use of the determined motion compensation interpolation filter.

31. A computer readable medium comprising a bitstream including coded data representative of a video, and an information enabling or disabling a use of the determined motion compensation interpolation filter.

32-33. (canceled)

34. A computer readable storage medium having stored thereon instructions for causing one or more processors to perform the method of claim 1.

35. (canceled)

36. The apparatus of claim 2, further comprising:
at least one of (i) an antenna configured to receive a signal, the signal including data representative of the video, (ii) a band limiter configured to limit the received signal to a band of frequencies that includes the data representative of the video, or (iii) a display configured to display the video.

37. The apparatus of claim 36, comprising a television (TV), a cell phone, a tablet or a set top box.

38. The apparatus of claim 4, further comprising:
an accessing unit configured to access data comprising a signal storing a computer readable medium according to claim 31, and
a transmitter configured to transmit the accessed data.

39. (canceled)
